(19) United States
(12) Patent Application Publication
(10) Pub. No.: US 2026/0204238 A1
(43) Pub. Date: Jul. 16, 2026

(54) MULTI-PANEL DISPLAY METHOD AND APPARATUS THEREOF

(71) Applicant: MediaTek Singapore Pte. Ltd., Singapore (SG)

(72) Inventor: Zhangjun YU, Wuhan (CN)

(21) Appl. No.: 19/246,939

(22) Filed: Jun. 24, 2025

(30) Foreign Application Priority Data
Jan. 15, 2025 (CN) 202510069307.5

(51) Int. Cl. G09G 5/12; G06F 3/14

(52) U.S. Cl. CPC G09G 5/12; G06F 3/1446; G09G 2300/026; G09G 2340/0435

(57) ABSTRACT

A multi-panel display method is provided. The multi-panel display method may include the following steps. A processor of an apparatus may perform a plurality of applications on a plurality of display devices of the apparatus. Then, the processor may also process the data of the plurality of applications performed on different display devices according to a frame per second (FPS) that corresponds to each respective display device. Then, the processor may further display the processed data of the plurality of applications on the plurality of display devices respectively.

### CROSS REFERENCE TO RELATED APPLICATIONS

This Application claims priority of China Patent Application No. 202510069307.5, filed on Jan. 15, 2025, the entirety of which is incorporated by reference herein.

### BACKGROUND OF THE INVENTION

### Field of the Invention

The invention generally relates to multi-panel display technology, and more particularly, it relates to a multi-panel display technology in which the data displayed on different panels are processed respectively according to the frame per second (FPS) of each panel.

### Description of the Related Art

With the development of display technologies, there are more requirements on multi-panel displays. In conventional multi-panel display technology, when different applications (APP) are performed on different display devices of an apparatus, the apparatus may process the data corresponding to the different display devices serially. That is, the apparatus may need to process the data corresponding to different display devices in order. For example, the apparatus may process the data of one display device first, and then process the data of another display device.

However, when the APPs are performed on different display devices of an apparatus, the apparatus may process the data of the APPs based on the frame per second (FPS) corresponding to the main display device of the apparatus. That is, each display device may need to correspond to the same SurfaceFlinger (SF) vertical synchronization (VSYNC) signal and the same interrupt signal. Therefore, when the display devices of the apparatus correspond to different FPSs, more power consumption and worse user experience may be generated.

Therefore, how to reduce the above problem with multi-panel displays is a topic that is worthy of discussion.

### BRIEF SUMMARY OF THE INVENTION

A multi-panel display method and apparatus are provided to overcome the problems mentioned above.

An embodiment of the invention provides a multi-panel display method. The multi-panel display method may comprise the following steps. A processor of an apparatus may perform a plurality of applications on a plurality of display devices of the apparatus. Then, the processor may also process the data of the plurality of applications performed on different display devices according to the frame per second (FPS) that corresponds to each respective display device. Then, the processor may further display the processed data of the applications on the display devices respectively.

In some embodiments, the processor may respectively generate the drawn data of each application performed on different display devices according to the data after receiving a respective application synchronization signal corresponding to each display device.

In some embodiments, the processor may respectively process the drawn data of each application performed on different display devices using a graphics compositing module after receiving a respective vertical synchronization signal corresponding to each display device to generate composited data of each application performed on different display devices.

In some embodiments, the processor may respectively process the composited data of each application performed on different display devices using a hardware composer module to generate the processed data.

In some embodiments, the processor may respectively display the processed data on different display devices after receiving a respective interrupt signal corresponding to each vertical synchronization signal.

In some embodiments, the data of the applications performed on different display devices is processed through a multi-tread operation or a single tread operation.

In some embodiments, the FPS corresponding to each respective display device may be different.

An embodiment of the invention provides a multi-panel display apparatus. The multi-panel display apparatus may include a plurality of display devices and a processor. The processor may be coupled to the display devices. The processor may be configured to perform a plurality of applications on a plurality of display devices, process data of the plurality of applications performed on different display devices according to the frame per second (FPS) that corresponds to each respective display device, and display the processed data of the applications on the display devices respectively.

Other aspects and features of the invention will become apparent to those with ordinary skill in the art upon review of the following descriptions of specific embodiments of multi-panel display method and an apparatus.

### BRIEF DESCRIPTION OF THE DRAWINGS

The invention will become more fully understood by referring to the following detailed description with reference to the accompanying drawings, wherein:

FIG. 1 is a block diagram of a multi-panel display apparatus 100 according to an embodiment of the application.

FIG. 2 is a schematic diagram illustrating a multi-panel display application scenario according to an embodiment of the invention.

FIG. 3 is a schematic diagram illustrating a multi-panel display process according to an embodiment of the invention.

FIG. 4 is a flow chart illustrating a multi-panel display method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

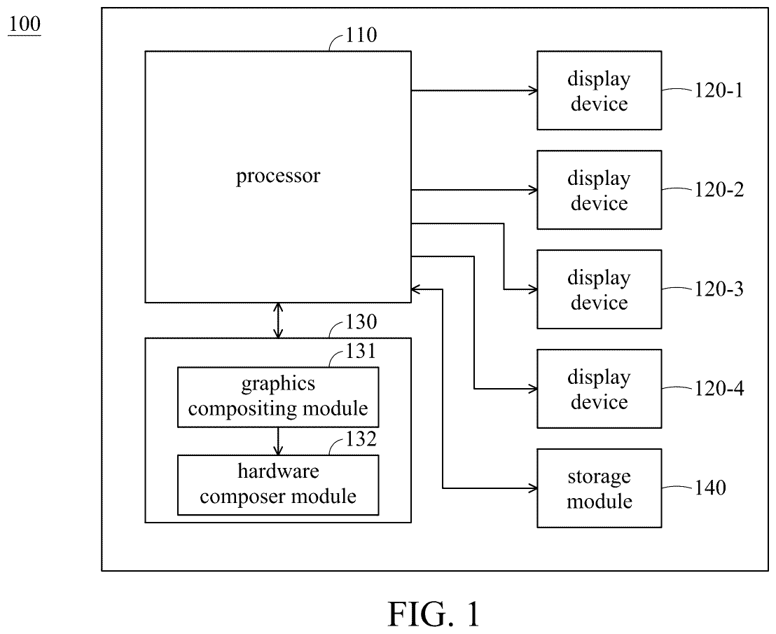

FIG. 1 is a block diagram of a multi-panel display apparatus 100 according to an embodiment of the application. As shown in FIG. 1, the multi-panel display apparatus 100 may comprise a processor 110, display devices 120-1-120-4, a graphic function modules and circuits 130, and a storage device 140. It should be noted that FIG. 1 presents a simplified block diagram in which only the elements relevant to the invention are shown. However, the invention should not be limited to what is shown in FIG. 1. For example, the multi-panel display apparatus 100 may comprise other elements. In addition, the multi-panel display apparatus 100 may comprise other number of display devices.

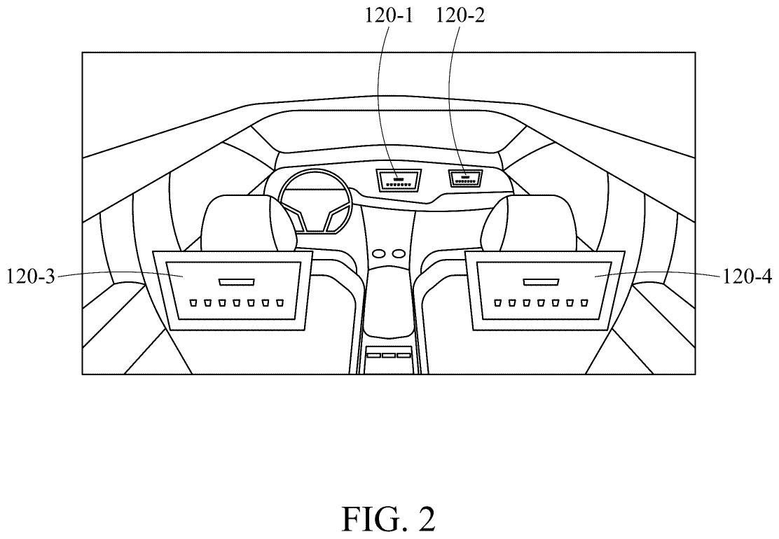

The multi-panel display apparatus 100 may be an electronic device with multi-panel display function, e.g., an on-board computer, but the invention should not be limited thereto. FIG. 2 is a schematic diagram illustrating a multi-panel display application scenario according to an embodiment of the invention. As shown in FIG. 2, the multi-panel display apparatus 100 may be configured in a car. The processor 110 of the multi-panel display apparatus 100 may control the display contents of the display devices 120-1~120-4. The display devices 120-1~120-4 may display the same or different contents for different applications (APPs).

The processor 110 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing to control the display devices 120-1~120-4, the graphic function modules and circuits 130, and the storage device 140. The processor 110 may coordinate the operations of the display devices 120-1~120-4, the graphic function modules and circuits 130, and the storage device 140 for performing the method of the present application.

In some embodiments, the multi-panel display apparatus 100 may further comprise two processors, e.g. a CPU and a GPU. The GPU may be used to offload graphic (or image) processing tasks from the CPU. In some examples, the CPU and the GPU may be formed in an integrated circuit (IC). For example, the IC may be considered as a processing chip within a chip package, or it may be considered to be a system on a chip or portion thereof. In some examples, the CPU and the GPU may be housed in different integrated circuits (i.e., different chip packages).

Examples of the CPU and the GPU may include, but are not limited to, a digital signal processor (DSP), general purpose microprocessor, application specific integrated circuit (ASIC), field programmable logic array (FPGA), or other equivalent integrated or discrete logic circuitry. In some examples, the GPU may be specialized hardware that includes integrated and/or discrete logic circuitry that provides the GPU with massive parallel processing capabilities suitable for graphics processing. In some instances, the GPU may also include general purpose processing capabilities, and may be referred to as a general purpose GPU (GPGPU) when implementing general purpose processing tasks (i.e., non-graphics related tasks).

As will be appreciated by persons skilled in the art, the circuits of the processor 110 (e.g., CPU or GPU) may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The display devices 120-1-120-4 may be Liquid-Crystal Displays (LCDs), Light-Emitting Diode (LED) displays, Organic LED (OLED) displays, or an Electronic Paper Displays (EPDs), etc., for providing a display function. Alternatively, the display devices 120-1-120-4 may further include one or more touch sensors for sensing touches, contacts, or approximations of objects, such as fingers or styluses. The display devices 120-1-120-4 may respectively display different contents corresponding to different applications performed by the user (or users).

The graphic function modules and circuits 130 may comprise a graphics compositing module 131 (e.g., SurfaceFlinger of Android system) and a hardware composer module 132 (e.g., hardware composer (HWC) hardware abstraction layer (HAL) of Android system). The processor 110 may execute different modules or circuits in the function modules and circuits 130 to perform embodiments of the present invention. It should be noted that the graphic function modules and circuits 130 of FIG. 1 presents a simplified block diagram in which only the elements relevant to the invention are shown. However, the invention should not be limited to what is shown in FIG. 1. The graphic function modules and circuits 130 may further comprise other graphic function modules and/or circuits. According to the embodiments of the invention, the multi-panel display apparatus 100 may further comprise a display controller (not shown in FIG. 1) to receive the data and signal from hardware composer module 132 to display the data from the hardware composer module 132 on the display devices 120-1-120-4.

The storage device 140 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

According to an embodiment of the invention, an apparatus (e.g., multi-panel display apparatus 100) may perform different applications (APPs) on its different display devices (e.g., display devices 120-1-120-4). Then, the apparatus may process the data of the applications performed on different display devices according to the frame per second (FPS) of each display device respectively. Then, each display device may display the processed data of its corresponding application respectively. That is to say, according to the embodiments of the invention, each display device of the apparatus can display data based on its FPS respectively.

Specifically, when the applications (APPs) performed on the different display devices of the apparatus, the apparatus may draw the data of the applications respectively based on the FPS of each display device after the application synchronization signal (e.g., APP vertical synchronization signal (e.g., APP VSYNC signal) corresponding to each display device are generated. When the apparatus performs a frame data of an application, an application synchronization signal will be generated. Accordingly, when the apparatus performs a next frame data of the application, another application synchronization signal will be generated.

Then, the drawn data of each APP may be respectively transmitted to the graphics compositing module (e.g., SurfaceFlinger (SF) of Android system) of the apparatus. Specifically, after the graphics compositing module receives the vertical synchronization signal (e.g., SF VSYNC signal) corresponding to each display device, the graphics compositing module may respectively process the drawn data (e.g., parse and composite the drawn data) of each APP performed on different display devices to generate composited data corresponding to each display device. The composited data may comprise the information of different graphic layers of the drawn data, e.g., the position of the graphic layers, the orders of the graphic layers, and so on. According to an embodiment of the invention, the graphics compositing module may process the drawn data of each APP performed on different display devices through a multi-tread operation or a single tread operation.

After the graphics compositing module (e.g., SurfaceFlinger) composite the drawn data of each APP performed on different display devices, the graphics compositing module may transmit the composited data to the hardware composer module (e.g., HWC HAL of Android system). The hardware composer module may process the composited data (e.g., compose the composited data) of each APP performed on different display devices respectively to generate composed data or overlay (OVL) data (i.e., the processed data, e.g., a frame image) corresponding to each APP performed on different display devices. According to an embodiment of the invention, the hardware composer module may process the composited data of each APP performed on different display devices through a multi-tread operation or a single tread operation.

After the hardware composer module receives the interrupt signal corresponding to each display device, the hardware composer module may transmit the composed data corresponding to each APP performed on different display devices to different display devices. Then, the display devices may display the composed data (i.e., the processed data) from the hardware composer module.

Each interrupt signal may be corresponded to a vertical synchronization signal (e.g., SF VSYNC signal). The length of the duration (i.e., a frame length) between the vertical synchronization signal and its corresponding interrupt signal may be based on the FPS of the display device. For example, if the FPS of a display device is 60 hertz (HZ), the length of duration between the vertical synchronization signal corresponding to the display device and its corresponding interrupt signal is 16.6 milliseconds (ms) (i.e., 1/60 second). Therefore, according to the embodiments of the invention, each display device can display the data of APPs based on its FPS.

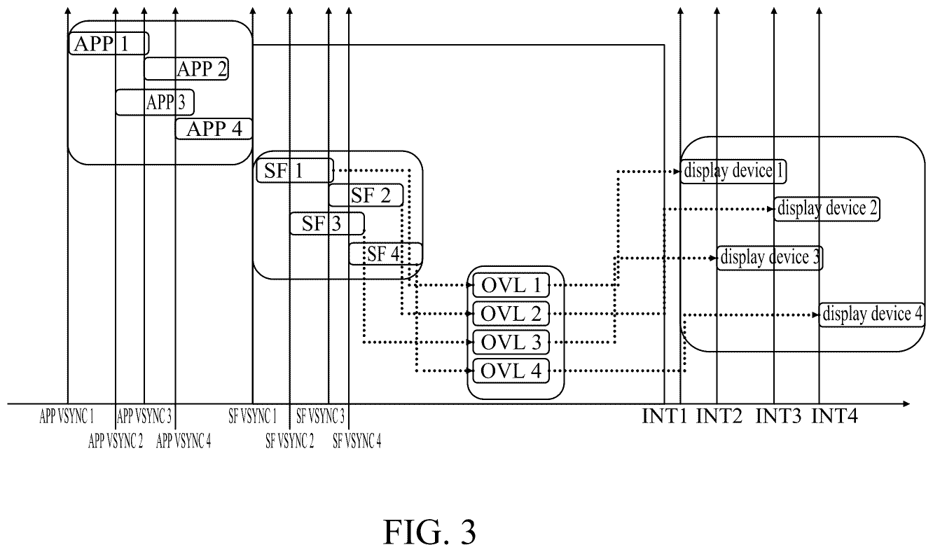

FIG. 3 is a schematic diagram illustrating a multi-panel display process with multi-treads according to an embodiment of the invention. As shown in FIG. 3, an apparatus may comprise four display devices. The APP 1 is performed on the display device 1, the APP 2 is performed on the display device 2, the APP 3 is performed on the display device 3, and the APP 4 is performed on the display device 4. The apparatus may draw the data of the APP1 based on the FPS of display device 1 after the application synchronization signal corresponding to the display device 1 (i.e., APP VSYNC 1) is generated. The apparatus may also draw the data of the APP 2 based on the FPS of display device 2 after the application synchronization signal corresponding to the display device 2 (i.e., APP VSYNC 2) is generated. The apparatus may also draw the data of the APP 3 based on the FPS of display device 3 after the application synchronization signal corresponding to the display device 3 (i.e., APP VSYNC 3) is generated. The apparatus may also draw the data of the APP4 based on the FPS of display device 4 after the application synchronization signal corresponding to the display device 4 (i.e., APP VSYNC 4) is generated.

Then, the drawn data corresponding to APP 1 may be transmitted to the graphics compositing thread SF 1 corresponding to the display device 1 after the vertical synchronization signal corresponding to the display device 1 (i.e., SF VSYNC 1) is generated. The drawn data corresponding to APP 2 may be transmitted to the graphics compositing thread SF 2 corresponding to the display device 2 after the vertical synchronization signal corresponding to the display device 2 (i.e., SF VSYNC 2) is generated. The drawn data corresponding to APP 3 may be transmitted to the graphics compositing thread SF 3 corresponding to the display device 3 after the vertical synchronization signal corresponding to the display device 3 (i.e., SF VSYNC 3) is generated. The drawn data corresponding to APP 4 may be transmitted to the graphics compositing thread SF 4 corresponding to the display device 4 after the vertical synchronization signal corresponding to the display device 3 (i.e., SF VSYNC 4) is generated. That is, when the graphics compositing module (e.g., SurfaceFlinger) receives the vertical synchronization signals SF VSYNC 1, SF VSYNC 2, SF VSYNC 3 and SF VSYNC 4 respectively, the graphics compositing module may process the drawn data corresponding to the APP 1-APP 4 respectively through the graphics compositing threads SF 1-SF 4.

Then, the graphics compositing module may transmit composited data corresponding to the display device 1 from the graphics compositing thread SF 1 to the OVL thread OVL 1 corresponding to the display device 1. The graphics compositing module may also transmit composited data corresponding to the display device 2 from the graphics compositing thread SF 2 to the OVL thread OVL 2 corresponding to the display device 2. The graphics compositing module may also transmit composited data corresponding to the display device 3 from the graphics compositing thread SF 3 to the OVL thread OVL 3 corresponding to the display device 3. The graphics compositing module may also transmit composited data corresponding to the display device 4 from the graphics compositing thread SF 4 to the OVL thread OVL 4 corresponding to the display device 4.

Then, after the hardware composer module respectively receives the interrupt signal (i.e., INT 1, INT 2, INT 3 and INT 4) corresponding to each display device, the hardware composer module may respectively transmit the composed data (or the processed data) corresponding to APP41, APP 2, APP43 and APP 4 to the display device 1, display device 2, display device 3 and display device 4. That is, the display device 1 may display the composed data from the OVL thread OVL 1. The display device 2 may display the composed data from the OVL thread OVL 2. The display device 3 may display the composed data from the OVL thread OVL 3. The display device 4 may display the composed data from the OVL thread OVL 4.

It should be noted that the multi-panel display process shown in FIG. 3 is based on multi-treads operation, but the invention should not be limited thereto. The multi-panel display process also can be realized through single tread operation.

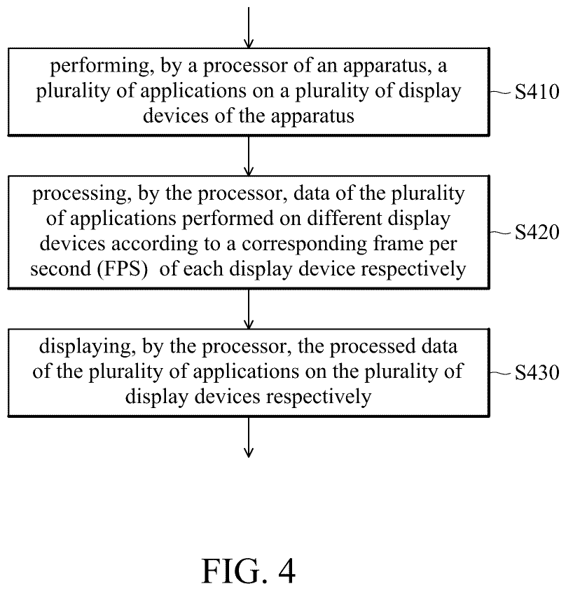

FIG. 4 is a flow chart illustrating a multi-panel display method according to an embodiment of the invention. The multi-panel display method can be applied to the multi-panel display apparatus 100. As shown in FIG. 4, in step S410, a processor of the multi-panel display apparatus 100 may perform a plurality of applications on a plurality of display devices of the multi-panel display apparatus 100.

In step S420, the processor may process the data of the plurality of applications performed on different display devices according to the frame per second (FPS) that corresponds to each respective display device.

In step S430, the processor may display the processed data of the plurality of applications on the plurality of display devices respectively.

According to an embodiment of the invention, in the multi-panel display method, the processor may respectively generate drawn data of each application performed on different display devices according to the data after receiving a respective application synchronization signal corresponding to each display device.

According to an embodiment of the invention, in the multi-panel display method, the processor may respectively process the drawn data of each application performed on different display devices through a graphics compositing module after receiving a respective vertical synchronization signal corresponding to each display device to generate composited data of each application performed on different display devices.

According to an embodiment of the invention, in the multi-panel display method, the processor may respectively process the composited data of each application performed on different display devices through a hardware composer module to generate the processed data.

According to an embodiment of the invention, in the multi-panel display method, the processor may respectively display the processed data on different display devices after receiving a respective interrupt signal corresponding to each vertical synchronization signal.

According to an embodiment of the invention, in the multi-panel display method, the data of the plurality of applications performed on different display devices may be processed through a multi-tread operation or a single tread operation.

According to an embodiment of the invention, in the multi-panel display method, the FPS corresponding to each respective display device may be different.

According to the multi-panel display method provided in the invention, the apparatus can respectively process the data corresponding to different APPs respectively displayed on different display devices of the apparatus according to the FPS of each display device. The method and device for multi-panel display of the present invention can achieve different refresh rates and different FPS for multiple panels, allowing the FPS of multiple panels to be individually set according to the needs of users or designers. This brings about the technical effects of saving system power and providing convenience and flexibility.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

1. A multi-panel display method, comprising:
performing, by a processor of an apparatus, a plurality of applications on a plurality of display devices of the apparatus, wherein the plurality of display devices comprise a first display device and a second display device;
processing, by the processor, data of the plurality of applications performed on different display devices according to a frame per second (FPS) that corresponds to each respective display device, wherein a first FPS corresponding to the first display device is different than a second FPS corresponding to the second display device; and
displaying, by the processor, the processed data of the plurality of applications on the plurality of display devices respectively.

2. The multi-panel display method of claim 1, wherein in processing the data of the plurality of applications further comprises:
respectively generating, by the processor, drawn data of each application performed on different display devices according to the data after receiving a respective application synchronization signal corresponding to each display device.

3. The multi-panel display method of claim 2, further comprising:
respectively processing, by the processor, the drawn data of each application performed on different display devices through a graphics compositing module after receiving a respective vertical synchronization signal corresponding to each display device to generate composited data of each application performed on different display devices.

4. The multi-panel display method of claim 3, further comprising:
respectively processing, by the processor, the composited data of each application performed on different display devices through a hardware composer module to generate the processed data.

5. The multi-panel display method of claim 4, further comprising:
respectively displaying, by the processor, the processed data on different display devices after receiving a respective interrupt signal corresponding to each vertical synchronization signal.

6. The multi-panel display method of claim 1, wherein the data of the plurality of applications performed on different display devices is processed through a multi-tread operation or a single tread operation.

7. The multi-panel display method of claim 1, wherein the FPS corresponding to each respective display device is different.

8. A multi-panel display apparatus, comprising:
a plurality of display devices; and
a processor, coupled to the plurality of display devices, and configured to:
perform a plurality of applications on a plurality of display devices, wherein the plurality of display devices comprise a first display device and a second display device;
process data of the plurality of applications performed on different display devices according to a frame per second (FPS) that corresponds to each respective display device, wherein a first FPS corresponding to the first display device is different than a second FPS corresponding to the second display device; and
display the processed data of the plurality of applications on the plurality of display devices respectively.

9. The multi-panel display apparatus of claim 8, wherein the processor is further configured to:
respectively generate drawn data of each application performed on different display devices according to the data after receiving a respective application synchronization signal corresponding to each display device.

10. The multi-panel display apparatus of claim 9, wherein the processor is further configured to:
respectively process the drawn data of each application performed on different display devices through a graphics compositing module after receiving a respective vertical synchronization signal corresponding to each display device to generate composited data of each application performed on different display devices.

11. The multi-panel display apparatus of claim 10, wherein the processor is further configured to:
respectively process the composited data of each application performed on different display devices through a hardware composer module to generate the processed data.

12. The multi-panel display apparatus of claim 11, wherein the processor is further configured to:
respectively display the processed data on different display devices after receiving a respective interrupt signal corresponding to each vertical synchronization signal.

13. The multi-panel display apparatus of claim 8, wherein the data of the plurality of applications performed on different display devices is processed through a multi-tread operation or a single tread operation.

14. The multi-panel display apparatus of claim 8, wherein the FPS corresponding to each respective display device is different.
